(19) United States
(12) Patent Application Publication
(10) Pub. No.: US 2026/0186841 A1
(43) Pub. Date: Jul. 2, 2026

(54) METHOD OF EXECUTING PROGRAM USING PLURALITY OF HARDWARE RESOURCES AND ELECTRONIC DEVICE FOR PERFORMING THE METHOD

(71) Applicant: SAMSUNG ELECTRONICS CO., LTD., Suwon-si (KR)

(72) Inventors: Jaejun CHANG, Suwon-si (KR); Sangyoon LEE, Suwon-si (KR); Jaehyung JANG, Suwon-si (KR); Taesin HA, Suwon-si (KR)

(73) Assignee: SAMSUNG ELECTRONICS CO., LTD., Suwon-si (KR)

(21) Appl. No.: 19/310,325

(22) Filed: Aug. 26, 2025

(30) Foreign Application Priority Data
Dec. 30, 2024 (KR) 10-2024-0200652

(51) Int. Cl. G06F 9/50

(52) U.S. Cl. CPC G06F 9/5027

(57) ABSTRACT

A program execution method may include obtaining a target program configured to present a workflow for an experiment conducted via an external electronic device configured to control a plurality of hardware resources, obtaining a first request to assign a hardware resource having a first feature among the plurality of hardware resources to a first data variable, based on the target program, transmitting the first request to the external electronic device, receiving, from the external electronic device, information about a first hardware resource having the first feature in response to the first request, obtaining a second request to perform a first function associated with the first data variable to which the first hardware resource is assigned based on the target program; transmitting the second request to the external electronic device, and receiving, from the external electronic device, a first result of the first function in response to the second request.

### CROSS-REFERENCE TO RELATED APPLICATION

This application claims priority from Korean Patent Application No. 10-2024-0200652, filed on Dec. 30, 2024, in the Korean Intellectual Property Office, the disclosure of which is incorporated herein by reference in its entirety.

### BACKGROUND

### 1. Field

Methods and apparatuses consistent with embodiments relate to executing a software program for an experiment. More particularly, embodiments relate to technology for executing a program to use hardware resources efficiently.

### 2. Description of the Related Art

Research activities are conducted not only using a pre-defined or previously established experimental setup, but more commonly through experiments that have never been conducted before. As a result, outcomes in the mid-process of an experiment are typically unknown beforehand. When designing an experiment workflow using an experiment platform, subsequent steps may need to be controlled or adapted based on an interim result of the experiment in some cases. For example, the direction of the next process may vary depending on whether a target object is in a solid or liquid state, as determined by the interim result. For another example, a particular process may have to be repeated until the interim result reaches a specific value. To express this kind of experiment as a software program executed by a computer, a programming language is needed to define the workflow and support the feature of returning an interim result during the execution of the program.

### SUMMARY

One or more embodiments may address at least the above problems and/or disadvantages and other disadvantages not described above. Also, the embodiments are not required to overcome the disadvantages described above, and one or more embodiments may not overcome any of the problems described above.

According to an aspect of the present disclosure, a program execution method performed by an electronic device, may include: obtaining a target program configured to present a workflow for an experiment conducted via an external electronic device configured to control a plurality of hardware resources; obtaining a first request to assign a hardware resource having a first feature among the plurality of hardware resources to a first data variable, based on the target program; transmitting the first request to the external electronic device; receiving, from the external electronic device, information about a first hardware resource having the first feature in response to the first request; obtaining a second request to perform a first function associated with the first data variable to which the first hardware resource is assigned based on the target program; transmitting the second request to the external electronic device; and receiving, from the external electronic device, a first result of the first function in response to the second request.

The target program may include source code written based on an imperative programming language.

The obtaining of the first request may include: converting a first script of the target program into one or more tokens; generating nodes of an abstract syntax tree (AST) for the one or more tokens; and obtaining the first request based on the nodes of the AST.

The transmitting of the first request to the external electronic device may include: transmitting the first request to a resource management device of the external electronic device configured to manage a state of the plurality of hardware resources.

The first feature may include at least one of a type, capacity, or function of the first hardware resource.

The type of the hardware resource may include at least one of a material, a container, or equipment.

The first function may include at least one of an operation type, operating time, or standby time of the first hardware resource.

The program execution method may include: obtaining a third request to assign a hardware resource having a second feature among the plurality of hardware resources to a second data variable, based on the target program; transmitting the third request to the external electronic device; and receiving, from the external electronic device, information about a second hardware resource having the second feature in response to the third request, wherein the obtaining of the second request may include: obtaining the second request to perform the first function associated with the first data variable, based on the second data variable to which the second hardware resource is assigned.

The program execution method may include: performing the first function and a second function in parallel and obtaining a fourth request to perform a third function based on the first result of the first function and a second result of the second function; transmitting the fourth request to the external electronic device; and receiving, from the external electronic device, a third result of the third function in response to the fourth request.

The electronic device and the external electronic device are included in a server.

A non-transitory computer-readable storage medium storing instructions that, when executed by a processor, may cause the processor to perform the program execution method.

According to another aspect of the present disclosure, an electronic device may include: at least one processor including processing circuitry; and a memory including one or more storage media configured to store instructions. The instructions, when executed individually or collectively by the at least one processor, may cause the electronic device to obtain a target program configured to present a workflow for an experiment conducted via an external electronic device configured to control a plurality of hardware resources, obtain a first request to assign a hardware resource having a first feature among the plurality of hardware resources to a first data variable, based on the target program, transmit the first request to the external electronic device, receive, from the external electronic device, information about a first hardware resource having the first feature in response to the first request, obtain a second request to perform a first function associated with the first data variable to which the first hardware resource is assigned based on the target program, transmit the second request to the external electronic device, and receive, from the external electronic device, a first result of the first function in response to the second request.

The first feature may include at least one of a type, capacity, or function of the first hardware resource, and the type of the hardware resource may include at least one of a material, a container, or equipment.

The first function may include at least one of an operation type, operating time, or standby time of the first hardware resource.

The electronic device and the external electronic device are included in a server.

According to another aspect of the present disclosure, a program execution method performed by a server, may include: obtaining a target program configured to present a workflow for an experiment conducted via at least one of a plurality of hardware resources connected to the server; obtaining a first request to assign a hardware resource having a first feature among the plurality of hardware resources to a first data variable, based on the target program; determining a first hardware resource having the first feature based on the first request; assigning the first hardware resource to the first data variable; obtaining a second request to perform a first function associated with the first data variable; performing the first function on the first hardware resource based on the second request; and obtaining a first result of the first function.

The determining of the first hardware resource may include: determining a hardware resource in an idle state, from among one or more candidate hardware resources having the first feature within the plurality of hardware resources, as the first hardware resource.

The determining of the first hardware resource may include: based on all candidate hardware resources having the first feature are in use, determining expected end times for the candidate hardware resources; and determining the first hardware resource from among the candidate hardware resources based on the expected end times.

The program execution method may include: obtaining a third request to assign a hardware resource having a second feature among the plurality of hardware resources to a second data variable, based on the target program; determining a second hardware resource having the second feature based on the third request; and assigning the second hardware resource to the second data variable, wherein the performing of the first function on the first hardware resource based on the second request may include: obtaining the second request to perform the first function associated the first data variable, based on the second data variable to which the second hardware resource is assigned.

The program execution method may include: performing the first function and a second function in parallel and obtaining a fourth request to perform a third function based on the first result of the first function and a second result of the second function; performing the third function based on the fourth request; and obtaining a third result of the third function.

### BRIEF DESCRIPTION OF THE DRAWINGS

The above and/or other aspects will be more apparent by describing certain embodiments with reference to the accompanying drawings, in which:

FIG. 1 is a diagram of a configuration of an electronic device according to one or more embodiments;

FIG. 2 is a diagram illustrating a system for performing an experiment, according to one or more embodiments;

FIG. 3 is a flowchart illustrating a method of executing a program, according to one or more embodiments;

FIG. 4 is a flowchart illustrating a method of obtaining a first request to allocate or assign a hardware resource having a first feature to a first data variable, according to one or more embodiments;

FIG. 5 is a flowchart illustrating a method of obtaining a second request to perform a first function for a first data variable, based on a second data variable to which a second hardware resource is allocated or assigned, according to one or more embodiments;

FIG. 6 is a flowchart illustrating a method of receiving a result of a third function performed based on results of a first function and a second function having performed in parallel, according to one or more embodiments;

FIG. 7 is a diagram illustrating a configuration of a server according to one or more embodiments;

FIG. 8 is a flowchart illustrating a method of executing a program performed by a server, according to one or more embodiments;

FIG. 9 is a flowchart illustrating a method of obtaining a second request to perform a first function for a first data variable, based on a second data variable to which a second hardware resource is allocated or assigned, according to one or more embodiments; and

FIG. 10 is a flowchart illustrating a method of obtaining a result of a third function performed based on results of a first function and a second function having performed in parallel, according to one or more embodiments.

### DETAILED DESCRIPTION

Hereinafter, embodiments will be described in detail with reference to the accompanying drawings. However, various alterations and modifications may be made to the example embodiments. Here, the example embodiments are not construed as limited to the disclosure. The embodiments should be understood to include all changes, equivalents, and replacements within the idea and the technical scope of the disclosure.

The terminology used herein is for the purpose of describing particular example embodiments only and is not to be limiting of the example embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like constituent elements and a repeated description related thereto will be omitted. In the description of example embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one constituent element from another constituent element, and the nature, the sequences, or the orders of the constituent elements are not limited by the terms. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

The same name may be used to describe an element included in the embodiments described above and an element having a common function. Unless otherwise mentioned, the descriptions on the embodiments may be applicable to the following embodiments and thus, duplicated descriptions will be omitted for conciseness.

A program for an experiment (hereinafter, a target program) may present a workflow that sequentially expresses processes for an experiment by using at least some of a plurality of hardware resources. For example, the target program may be source code written in an imperative programming language. The plurality of hardware resources includes experimental equipment, analytic equipment, containers, and materials to be used for experiments but is not limited to the embodiments described herein.

The imperative programming language may be a programming language that sequentially specifies algorithms by using declarations, expressions, and statements, such as python, C, and Java. By adding functions for experimental automation to declarations, expressions, and statements, experiments with a workflow desired by researchers (or experimental designers) may be expressed in a programming language. The imperative programming language allows the plurality of hardware resources of a system (or a platform) to operate efficiently.

The function of a declaration in the programming language of the present disclosure is to indicate that a given identifier is a variable, a function, or a structure. For example, the programming language may declare data variables that express a container that is being processed, the location of the container, and a material that is being processed and hardware resources such as experimental equipment. Because memory space for a specific hardware resource is allocated at the time when source code is executed (or when an experiment is performed), not at the time when the source code is written, the available hardware resources at the time of execution of the experiment may be assigned appropriately to the allocated memory space. For example, in a typical programming language, if a declaration like “int a;” is made, a section (or an address) with a specific size is allocated to a specific location in computer memory when a given program is executed, and an address value of the location has a data variable (or an identifier) a. Similar to how a memory address is allocated for data operations, the programming language described in the present disclosure may define a method of allocating memory spaces or addresses for hardware resources. This would allow data variables of the hardware resources (e.g., hardware resource IDs) to be assigned to the allocated memory spaces or addresses for use in experiments. For example, if a declaration “var a=Container(type=‘vial_1mL’);” is made in the source code, a vial with a size of 1 mL is assigned as a container, and the identifier of a first vial may be assigned to the data variable a. The first vial may be one of one or more vials that are idle upon the execution of the source code.

In the programming language of the present disclosure, an expression may refer to source code that necessarily produces at least one value. For example, the expression may include the four fundamental arithmetic operations of numbers or the conversions of strings. Various operations may be performed between commands that control hardware resources by using expressions of the programming language of the present disclosure. For example, to dispense a specific material during an experiment, the purity, concentration, or density of the specific material may be calculated, and the calculated result value may be inserted as a data variable in the source code for dispensing the specific material.

In the experimental research field, it is often difficult to predict which results would come in response to a given control command, and thus an interim value of the experiment may need to be obtained adaptively during the experiment. As the source code of a control command for hardware resources is treated as an expression, the result of carrying out the control command may be returned as a result value. Source code for the next control command may be written by using a data variable that contains the result value of the previously carried out control command. For example, how many test tubes were used after completing a purification process of a material, how much material each test tube contains, or what a value of ultraviolet-visible molecular absorption spectroscopy is for solution in each test tube. The returned result value may be used for the next control command.

In the programming language of the present disclosure, a sentence refers to source code that performs a specific function as a command and does not produce a result value. For example, the sentence includes assignment statements, loops, and conditional statements. An assignment statement refers to a statement that assigns the result value of an expression to a declared data variable. For example, the result value of an expression for a control command of a hardware resource may be assigned to a previously declared data variable by using an assignment statement. A loop refers to a statement that performs statements within the loop until a specific condition is satisfied. For example, a control command of the same hardware resource may be repeated by using a loop until the result value satisfies the specific condition. A conditional statement refers to a statement that selects statements to be performed under a condition. For example, a conditional statement may be used to select a control command of the next hardware resource, based on the result value of a control command of the previous hardware resource.

The programming language of the present disclosure may have various dedicated operators for experimental automation using the characteristics of the imperative language as described above. For example, the programming language of the present disclosure may provide researchers with various operational commands to control an automated experiment platform, such as a request for allocation of hardware resources, the occupying/releasing of hardware resources, a command to control hardware resources, the generation of a task graph structure for parallel processing of tasks, and the transmission of containers, and the researchers may write a program for performing an experiment with a desired workflow by using the programming language of the present disclosure.

In the present disclosure, the term “hardware resource” may refer to any physical component used in conducting or analyzing experiments, including but not limited to experimental equipment (e.g., dispensers, reactors, samplers), analytic equipment (e.g., sensors, measurement devices), containers (e.g., test tubes, beakers), and materials (e.g., solids, liquids, gases). These resources support various stages of the experimental process and may be standalone or integrated systems.

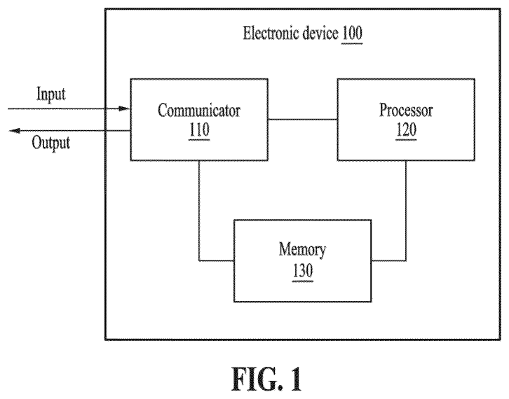

The method of executing a program using hardware resources is described in detail with reference to FIGS. 1 to 10 below.

FIG. 1 is a diagram of a configuration of an electronic device according to one or more embodiments.

An electronic device 100 may include a communicator 110, a processor 120, and a memory 130.

The communicator 110 may be connected to the processor 120 and the memory 130 and transmit and receive data to and from the processor 120 and the memory 130. The communicator 110 may be connected to another external device and transmit and receive data to and from the external device. The expression used herein “transmitting and/or receiving A” may be construed as transmitting and/or receiving information or data that indicates A.

The communicator 110 may be implemented by any one or any combination of a digital modem, a radio frequency (RF) modem, an antenna circuit, a WiFi chip, and related software and/or firmware. For example, the communicator 110 may include an internal bus and an external bus. In another example, the communicator 110 may be an element that connects the electronic device 100 to the external device. The communicator 110 may be a communication interface. The communicator 110 may receive data from the external device and transmit the data to the processor 120 and the memory 130.

The processor 120 may process the data received by the communicator 110 and data stored in the memory 130. A “processor” may be a hardware-implemented data processing device having a physically structured circuit to execute desired operations. The desired operations may include, for example, codes or instructions included in a program. The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 120 may execute computer-readable code (e.g., software) stored in a memory (e.g., the memory 130) and instructions triggered by the processor 120.

The memory 130 may store the data received by the communicator 110 and the data processed by the processor 120. For example, the memory 130 may store a program (or an application, or software). For example, the stored program may be a set of syntaxes that are coded to execute a program for an experiment using hardware resources and are executable by the processor 120.

The memory 130 may include, for example, at least one volatile memory, non-volatile memory, random-access memory (RAM), flash memory, a hard disk drive, and an optical disc drive.

The memory 130 may store an instruction set (e.g., software) for operating the electronic device 100. The instruction set for operating the electronic device 100 is executed by the processor 120.

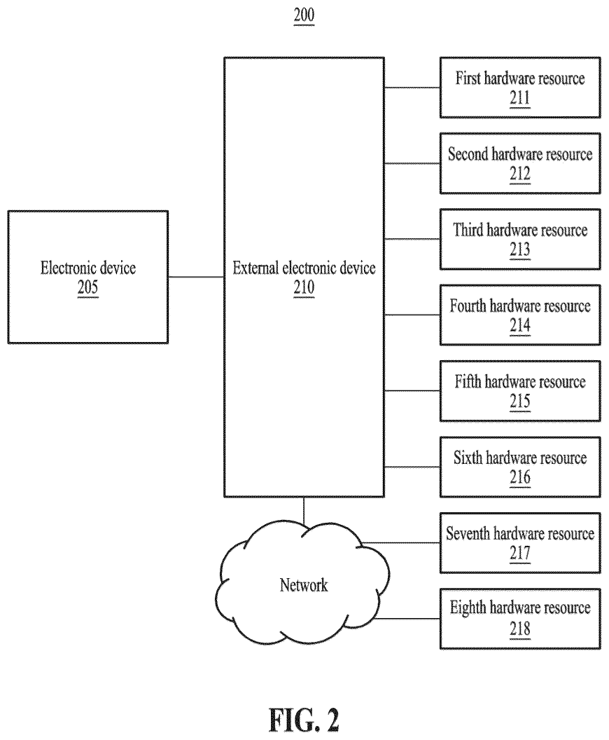

The communicator 110, the processor 120, and the memory 130 are described in detail below with reference to FIGS. 2 to 10.

FIG. 2 is a diagram illustrating a system for performing an experiment, according to one or more embodiments.

According to one or more embodiments, a system 200 for performing an experiment may include an electronic device 205 (e.g., the electronic device 100 of FIG. 1), an external electronic device 210, and a plurality of hardware resources 211 to 218. The system 200 may be referred to as a platform for an experiment.

The electronic device 205 may be a device that executes a program including source code in a programming language. For example, the electronic device 205 may execute the program by interpreting a script in the source code.

The plurality of hardware resources 211 to 218 includes experimental equipment, analytic equipment, containers, and materials to be used for experiments but is not limited to the embodiments described herein. For example, a material may include a first material in a liquid state, a second material in a solid state, or a third material in a gaseous state. For example, a container may be a hardware resource that may contain things, such as test tubes, vials, and beakers. For example, the experimental equipment may be hardware resources, such as dispensers, reactors, samplers, droppers, and shakers. For example, the analytic equipment may be a sensor capable of sensing values, such as the weight, volume, or density of a material, or equipment including the sensor. According to embodiments, the analytic equipment and the experimental equipment may be integrated.

The external electronic device 210 may be an experimental equipment. The external electronic device 210 may be directly connected to the plurality of hardware resources 211 to 218 via wired communication, or indirectly connected via wireless communication (e.g., short-range wireless communication or the Internet). In the configuration of the system 200, certain hardware resources, such as the hardware resources 211 to 216, may be directly or indirectly connected to the external electronic device 210 via wired communication or short-range wireless communication, whereas other hardware resources, such as the hardware resources 217 and 218, may be remotely connected to the external electronic device 210 over a network, such as the Internet.

The external electronic device 210 may generate commands to control the operation of the plurality of hardware resources 211 to 218. For example, if the first hardware resource 211 is a dispenser, the external electronic device 210 may generate a command to dispense 10 ml of a material from a first container into a second container and may transmit the generated command to the first hardware resource 211. The external electronic device 210 may manage the operational status of the plurality of hardware resources 211 to 218. The status of a hardware resource may include whether the hardware resource is currently in use for an experiment, its expected operation end time (e.g., an expected operation completion time), and any associated waiting time.

According to one or more embodiments, the electronic device 205 and the external electronic device 210 may be integrated into one device (e.g., a server). For example, the electronic device 205 and the external electronic device 210 may be implemented in a system-on-chip (SoC). For example, the electronic device 205 may be implemented as a first SoC of the server, and the external electronic device 210 may be implemented as a second SoC of the server.

According to one or more embodiments, the electronic device 205 and the external electronic device 210 may be separate devices within the system or the platform. For example, the electronic device 205 may be connected to the external electronic device 210 over the Internet.

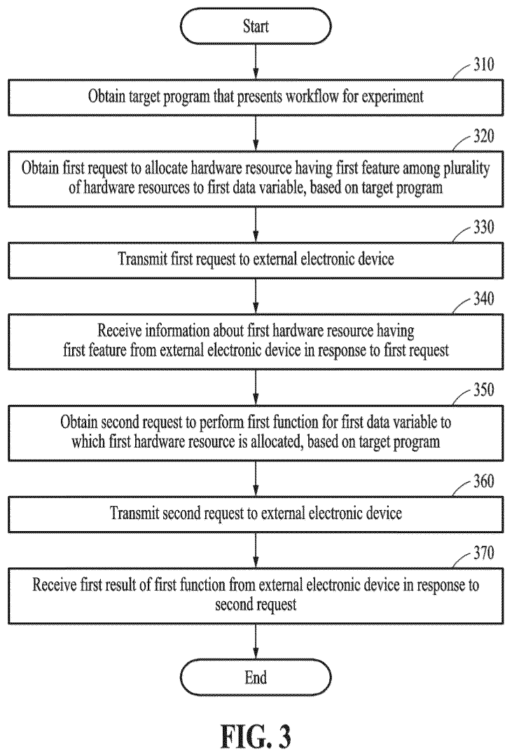

The method of executing a program for an experiment is described in detail below with reference to FIGS. 3 to 10.

FIG. 3 is a flowchart illustrating a method of executing a program, according to one or more embodiments.

The method of executing a program performed by an electronic device (e.g., the electronic device 100 of FIG. 1 or the electronic device 205 of FIG. 2) as described above with reference to FIGS. 1 and 2 may include operations 310 to 370.

In operation 310, the electronic device may obtain a target program that defines a workflow for conducting an experiment. For example, the electronic device may obtain the target program by receiving data corresponding to the target program, or by receiving an execution command (e.g., a compile or run command) of the target program from a user. Operations 320 to 370 may represent operations performed by the electronic device in response to analyzing or executing the source code of the target program.

In operation 320, the electronic device may obtain a first request to allocate or assign a hardware resource having a first feature among a plurality of hardware resources (e.g., the plurality of hardware resources 211 to 218 of FIG. 2) to a first data variable, based on the target program. For example, the first feature may pertain to one or more characteristics of the hardware resource, such as the type, capacity, and function of the hardware resource. Examples of hardware resource types may include, but are not limited to, a material, a container, and equipment.

For example, if the source code states “var containerR=Container(type=‘Vial_Reaction’);”, this line represents a request to assign a container with the type “Vial_Reaction”, indicating a reaction vessel, as a feature to a data variable containerR. Similarly, the statement “var containerS=Container(type=‘Vial_Sampling’);” in the source code, represents a request to assign a container with the type “Vial_Sampling,” indicating a sampling container, as a feature to the data variable containerS. In another example, the source code is “var dispenser=Device(function=‘dispensing’);” represents a request to assign a device having a dispensing function as a feature to a data variable dispenser. Likewise, the source code “var reactor=Device(function=‘reaction’);” assigns a device having a reaction function as a feature to a data variable reactor, and the source code “var dropper=Device(function=‘dropping’);” assigns a device having a dropping function as a feature to a data variable dropper. Each of these requests, as reflected in the source code examples, corresponds to a variable declaration that binds a hardware resource—identified by a specific feature such as type or function—to a programmatic data variable. These declarations illustrate an operation of the programming language used in the target program.

In operation 330, the electronic device may transmit the first request to an external electronic device (e.g., the external electronic device 210 of FIG. 2). According to one or more embodiments, the external electronic device may include a resource management device that manages the state of the plurality of hardware resources. The electronic device may transmit the first request to the resource management device of the external electronic device.

According to one or more embodiments, the external electronic device may determine a first hardware resource to be allocated or assigned to the first data variable, based on the first request. For example, the external electronic device may determine candidate hardware resources having the first feature among the plurality of hardware resources and may determine the first hardware resource among the determined candidate hardware resources.

According to one or more embodiments, a hardware resource in an idle state among the candidate hardware resources may be determined to be the first hardware resource. For example, if 100 vials having a capacity of 1 ml are managed by the external electronic device, 80 vials are currently in use, and 20 vials are idle, any one of the 20 idle vials may be determined as the first hardware resource.

According to one or more embodiments, if all the candidate hardware resources are currently in use, the first hardware resource may be determined or selected based on the expected end times (i.e., the expected completion times) of the ongoing operations of the candidate hardware resources. A hardware resource with the earliest projected end time may be determined or selected to be the first hardware resource. For example, if two dispensers are managed by the external electronic device and both the two dispensers are in use, a dispenser whose operation ends first may be determined to be the first hardware resource.

The external electronic device may transmit the identifier of the determined first hardware resource to the electronic device. The external electronic device may change the state of the first hardware resource from an idle state to an in-use state for management.

In operation 340, the electronic device may receive, from the external electronic device, information about the first hardware resource having the first feature in response to the first request. The information about the first hardware resource may be the identifier of the first hardware resource. The electronic device may allocate or assign the first hardware resource to the first data variable. For example, the identifier of the first data variable may be associated with the identifier of the first hardware resource.

In operation 350, the electronic device may obtain a second request to perform a first function for the first data variable to which the first hardware resource is allocated or assigned, based on the target program. For example, the first function may specify attributes such as the operation type, operating time (e.g., execution direction), and standby time of a hardware resource. The electronic device may generate a command, as the second request, to instruct equipment specified through source code to perform the first function by interpreting the source code of the target program.

According to one or more embodiments, if the first hardware resource is a device, the first function may correspond to a specific operation that the device is capable of performing. For example, if the first hardware resource is a dispenser, the first function may be a dispensing operation executed by the dispenser.

For example, if the source code states “hwcall dispenser.dispense(weight);”, hwcall represents a command that calls a function of the first hardware resource whose first data variable is dispenser, and dispense(weight) refers to the first function to dispense a quantity corresponding to the value of weight. The weight parameter may be predefined by using an expression in the programming language. For example, the source code statement “var weight=volume*density;” assigns to the data variable weight to the product of the volume and density of a sensed material. The values volume and density may be sensed in real time. An expression may be used to express a value (e.g., the weight of a material) of a parameter for a control command for hardware resources, based on a value (e.g., the volume and density of the material) obtained during the execution of a program. The volume and density of a material may be sensed by a device (e.g., an analytic device or a sensor), and the sensed values may be returned to the electronic device to be assigned to a specific data variable of the electronic device.

According to one or more embodiments, if the first hardware resource is a container, the first function may be an operation type of equipment (e.g., a second hardware resource) using a container. For example, if the second hardware resource is a sampler, the first function may be a sampling operation of the sampler. For example, if the source code of the request is “hwcall sampler.sampling(source=containerR, target=containerS);”, hwcall is a command that calls a function of a hardware resource whose data variable is sampler, and sampling(source=containerR, target=containerS) refers to the first function to sample a material in the first hardware resource whose first data variable is containerR to a hardware resource whose data variable is containerS.

In operation 360, the electronic device may transmit the second request to the external electronic device. The external electronic device that receives the second request may control equipment specified through the second request to perform the first function.

In operation 370, the electronic device may receive a first result of the first function from the external electronic device in response to the second request. For example, the first result may be an acknowledgement (ACK) indicating that the external electronic device has received the second request. For example, the first result refers that the specified equipment is operating the first function. For example, the first result may receive the result of performing the first function. For example, the second request instructed the equipment to sample 3.0 ml of a material, the first result may indicate that 3.01 ml was actually sampled. Such results may be generated by the equipment executing the first function or by an analytic device monitoring the first function.

Execution history or operation result values of a hardware resource generated during an experiment may be recorded as a log of the execution of a program. The execution history or operation result values may be output via an output interface such as a display or a communication interface, to enable a researcher who designed an experiment to interpret the meaning and significance of a specific value among the generated values, determine how to record the specific value, or determine whether to use the specific value in the next experiment. For example, where a researcher designs a heating reaction, a reactor is mounted to a heater when the temperature reaches 80 degrees, and the time of mounting the reactor may be considered the start time of the heating reaction in some experiments. In other experiments, an additional material may be added to the reactor that has already reached a target temperature, and the time of addition may be considered the start time of the heating reaction. As shown in the foregoing examples, the context of the obtained data may vary depending on every experiment, and thus the authority to record data should be given to researchers. The source code as shown below is source code to store experimental data.
var db_experiments=connectDB(ip, port, id, passwd, ‘db_experiments’); #DB connection
var test1=db_experiments.getTable(‘test1’); #table connection or generation
var ret=hwcall device.action(parameters);
test1.update({‘id_job’: 77}, {‘reaction_started’: ret[‘time’]}); #recording

The source code may be source code that records the value of a reaction start time reaction_started as the time value of a return value ret for an experiment with id_job being 77 in a table test1 in a database db_experiments. In addition, the create, read, update, and delete functions of a database may be implemented through source code. In addition, data input and output functions may be implemented through source code. In addition, input and output functions for a screen may be implemented through source code.

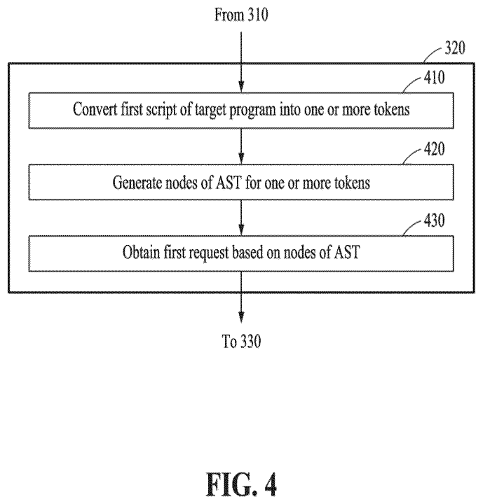

FIG. 4 is a flowchart illustrating a method of obtaining a first request to allocate or assign a hardware resource having a first feature to a first data variable, according to one or more embodiments.

According to one or more embodiments, operation 320 described above with reference to FIG. 3 may include operations 410 to 430 of FIG. 4. Operations 410 to 430 may be performed by an electronic device (e.g., the electronic device 100 of FIG. 1 or the electronic device 205 of FIG. 2).

In operation 410, the electronic device may convert a first script of a target program into one or more tokens. For example, the first script may be source code. A token refers to a term, a command, or a specified data variable in a programming language. For example, the electronic device may convert the first script into one or more tokens by using a prespecified library for the programming language. For example, the electronic device may use a token analyzer configured through a software module or a separate processing circuit to convert the first script into tokens expressed by numbers, strings, operators, keywords, or identifiers.

In operation 420, the electronic device may generate nodes of an abstract syntax tree (AST) for the one or more tokens. The electronic device may generate syntax nodes by organizing the one or more tokens based on a sequence pattern of the one or more tokens. The electronic device may generate the AST in the form of a tree in which the syntax nodes are interconnected by analyzing the syntax nodes. For example, the electronic device may generate the AST for the one or more tokens by using the syntax analyzer configured through the software module or the separate processing circuit.

In operation 430, the electronic device may obtain a first request based on the nodes of the AST. The electronic device may interpret the nodes of the AST sequentially. For example, the electronic device may generate the first request by using an executor configured through a software module or a separate processing circuit. The executor may execute an interpreter according to the type (e.g., a loop, an assignment statement, a determination statement, or an expression) of each node. Data generated by the execution of the interpreter may be managed through a memory manager. When a node relates to a request (e.g., the first request of operation 330 of FIG. 3) to allocate or assign a hardware resource or a request (e.g., the second request of operation 350 of FIG. 3) to perform a function of a hardware resource, the electronic device may generate the request (e.g., the first request or the second request) through a command generator. The electronic device may transmit the generated request to an external electronic device (e.g., the external electronic device 210 of FIG. 2).

According to one or more embodiments, the electronic device may execute the target program until a node indicating the end of an experiment appears.

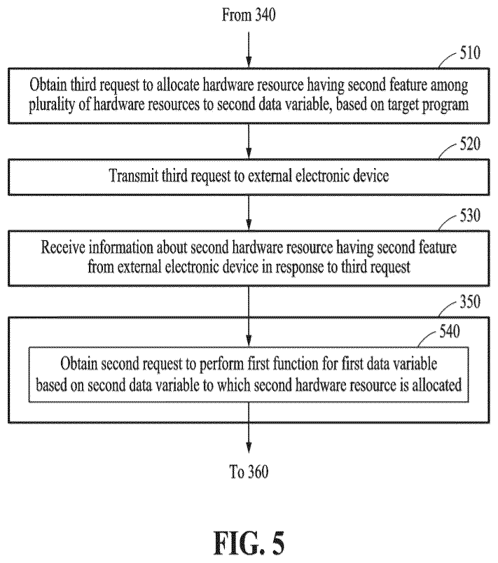

FIG. 5 is a flowchart illustrating a method of obtaining a second request to perform a first function for a first data variable, based on a second data variable to which a second hardware resource is allocated or assigned, according to one or more embodiments.

According to one or more embodiments, operations 510 to 530 of FIG. 5 may be performed after operation 340 described above with reference to FIG. 3 is performed. Operation 350 described above with reference to FIG. 3 may include operation 540 of FIG. 5. Operations 510 to 540 may be performed by an electronic device (e.g., the electronic device 100 of FIG. 1 or the electronic device 205 of FIG. 2).

In operation 510, the electronic device may obtain a third request to allocate or assign a hardware resource having a second feature among a plurality of hardware resources to a second data variable, based on a target program. For example, the hardware resource having the second feature may be a hardware resource that may perform a function using a hardware resource (e.g., a vial having a 1 ml capacity) having a first feature.

For example, the source code “var dispenser=Device(function=‘dispensing’);” assigns a device having a dispensing function as a feature to a data variable dispenser. For example, the source code “var reactor=Device(function=‘reaction’);” may assign a device having a reaction function as a feature to a data variable reactor. For example, the source code “var dropper=Device(function=‘dropping’);” may assign a device having a dropping function as a feature to a data variable dropper.

In operation 520, the electronic device may transmit the third request to an external electronic device (e.g., the external electronic device 210 of FIG. 2). The description of operation 330 described above with reference to FIG. 3 may similarly apply to the description of operation 520.

In operation 530, the electronic device may receive information about the second hardware resource having the second feature from the external electronic device in response to the third request. The description of operation 340 described above with reference to FIG. 3 may similarly apply to the description of operation 530.

In operation 540, the electronic device may obtain the second request to perform the first function for a first data variable based on the second data variable to which the second hardware resource is allocated or assigned.

For example, if a first hardware resource is a container, and the second hardware resource is a sampler, the first function may be a sampling operation of the sampler. For example, if the source code states “hwcall sampler.sampling(source=containerR, target=containerS);”, hwcall represents a command that calls a function of a hardware resource whose second data variable is sampler, and sampling(source=containerR, target=containerS) refers to the first function to sample a material in the first hardware resource whose first data variable is containerR to a hardware resource whose data variable is containerS.

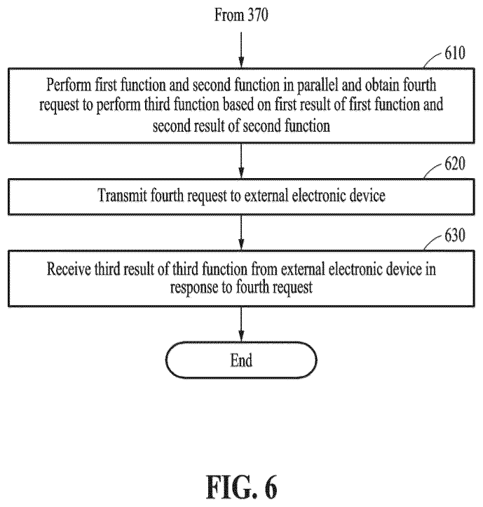

FIG. 6 is a flowchart illustrating a method of receiving a result of a third function performed based on results of a first function and a second function having performed in parallel, according to one or more embodiments.

According to one or more embodiments, operations 610 to 630 of FIG. 6 may be performed after operation 370 described above with reference to FIG. 3 is performed. Operations 610 to 630 may be performed by an electronic device (e.g., the electronic device 100 of FIG. 1 or the electronic device 205 of FIG. 2).

In operation 610, the electronic device may perform the first function and the second function in parallel and may obtain a fourth request to perform the third function based on a first result of the first function and a second result of the second function.

According to one or more embodiments, a function that performs a plurality of functions continuously may be expressed by source code as shown below.
function dispAndRx(container){
var dispenser=Device(function=‘dispensing’);
hwcall dispenser.dispense(container);
var reactor=Device(function=‘reaction’);
hwcall reactor.reactionStart( );
wait 600;
hwcall reactor.reactionstop( );}

The function may be defined as dispAndRx. Functions in the function may include the function of dispensing materials in a container through an assigned dispenser, the function of causing the materials to react in the container through an assigned reactor, and the function of terminating the reaction. A standby time may be set to 600 seconds between the function of causing the materials to react and the function of terminating the reaction in the function.

The source code as shown below may instruct a first function thread1 and a second function thread2 to be processed in parallel by using the function dispAndRx. The first function thread1 may be the execution of the function dispAndRx by using VialA, and the second function thread2 may be the execution of the function dispAndRx by using VialB.
var VialA=Container(type=‘reaction_Vial’);
var VialB=Container(type=‘reaction_Vial’);
thread1=run dispAndRx(VialA);
thread2=run dispAndRx(VialB);

The source code as shown below may instruct a third function drop to be executed by using a dropper after waiting until the first function thread1 and the second function thread2 are completed or terminated by using a wait command.
wait thread1, thread2;
var dropper=Device(function=‘dropping’);
run {hwcall dropper.drop(source=VialA, target=VialB);};

The source code as shown below may be source code that instructs the execution of the third function drop by using the dropper after performing the first function thread1 and the second function thread2 by using an after command.
var dropper=Device(function=‘dropping’);
run {hwcall dropper.drop(source=VialA, target=VialB);} after thread1, thread2

In operation 620, the electronic device may transmit the fourth request to an external electronic device (e.g., the external electronic device 210 of FIG. 2). The description of operation 330 described above with reference to FIG. 3 may similarly apply to the description of operation 620.

In operation 630, the electronic device may receive a third result of the third function from the external electronic device in response to the fourth request. The description of operation 340 described above with reference to FIG. 3 may similarly apply to the description of operation 630.

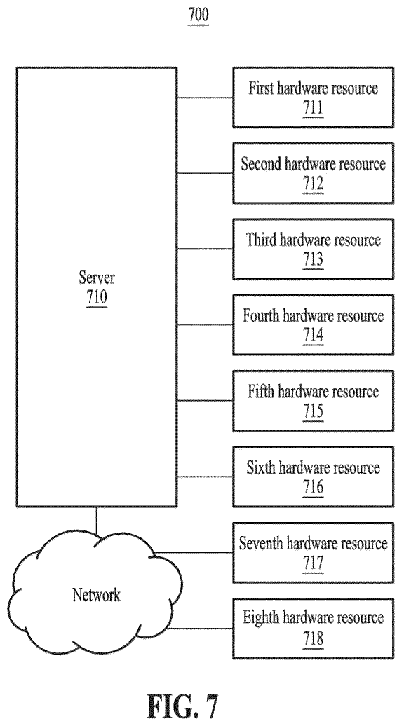

FIG. 7 is a diagram illustrating a configuration of a server according to one or more embodiments.

According to one or more embodiments, a system 700 for performing an experiment may include a server 710 and a plurality of hardware resources 711 to 718. The system 700 may be referred to as a platform for an experiment.

The server 710 may execute a program composed of source code in a programming language. The server 710 may be a single computing device that integrates the functions of the electronic device 205 and the external electronic device 210 described above with reference to FIG. 2. For example, the function of the electronic device 205 may be implemented as a first SoC of the server 710, and the function of the external electronic device 210 may be implemented as a second SoC of the server 710. The server 710 may execute the program by interpreting a script in the source code.

The server 710 may include a communicator (e.g., the communicator 110 of FIG. 1), at least one processor (e.g., the processor 120 of FIG. 1), and a memory (e.g., the memory 130 of FIG. 1).

The description of the plurality of hardware resources 211 to 218 described above with reference to FIG. 2 may similarly apply to the description of the plurality of hardware resources 711 to 718.

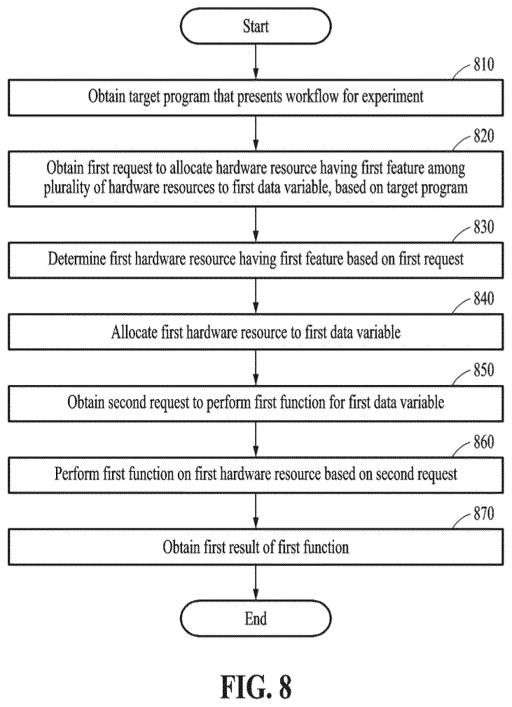

FIG. 8 is a flowchart illustrating a method of executing a program performed by a server, according to one or more embodiments.

The method of executing a program performed by a server (e.g., the server 710 of FIG. 7) may include operations 810 to 870.

In operation 810, the server may obtain a target program that presents a workflow for an experiment. For example, the server may obtain the target program by receiving data corresponding to the target program. For example, the server may obtain the target program by receiving an execution command (e.g., a compile command) of the target program from a user. Operations 820 to 870 may be operations of the server performed based on source code of the target program.

In operation 820, the server may obtain a first request to allocate or assign a hardware resource having a first feature among a plurality of hardware resources (e.g., the plurality of hardware resources 711 to 718 of FIG. 7) to a first data variable, based on the target program.

The description of operation 320 described above with reference to FIG. 3 may similarly apply to the description of operation 820.

In operation 830, the server may determine a first hardware resource having the first feature based on the first request.

According to one or more embodiments, the server may determine a first hardware resource to be allocated or assigned to the first data variable, based on the first request. For example, the server may determine candidate hardware resources having the first feature among the plurality of hardware resources and may determine the first hardware resource among the determined candidate hardware resources.

According to one or more embodiments, a hardware resource in an idle state among the candidate hardware resources may be determined to be the first hardware resource. For example, if 100 vials having a capacity of 1 ml are managed by the server, 80 vials are currently in use, and 20 vials are idle, any one of the idle 20 vials may be determined as the first hardware resource.

According to one or more embodiments, if all the candidate hardware resources are currently in use, the first hardware resource may be determined or selected based on the expected end times (i.e., the expected completion times) of the ongoing operations of the candidate hardware resources. A hardware resource with the earliest projected end time may be determined or selected to be the first hardware resource. For example, if two dispensers are managed by the server and both the two dispensers are in use, a dispenser whose operation ends first may be determined to be the first hardware resource.

The server may change the state of the first hardware resource from an idle state to an in-use state for management.

In operation 840, the server may allocate or assign the first hardware resource to the first data variable. For example, the server may allocate a memory space or address for the first hardware resource and assign attributes of the first hardware resource (e.g., its ID) to the first data variable in the allocated memory space or at the allocated address.

In operation 850, the server may obtain a second request to perform a first function for the first data variable to which the first hardware resource is allocated or assigned, based on a target program. For example, the first function may include at least one of the operation type, operating time, and standby time of a hardware resource. The server may generate a command, as the second request, to instruct equipment specified through source code to perform the first function by interpreting the source code of the target program.

The description of operation 350 described above with reference to FIG. 3 may similarly apply to the description of operation 850.

In operation 860, the server may perform the first function on the first hardware resource based on the second request. The server may control equipment specified through the second request to perform the first function.

In operation 870, the server may obtain a first result of the first function. For example, the first result refers that the specified equipment is operating the first function. For example, the first result may receive the result of performing the first function. For example, the first result may be generated in which the first function of the second request was supposed to sample 3.0 ml of a material, but 3.01 ml of the material was sampled. For example, the first result may be generated by the specified equipment or the analytic device.

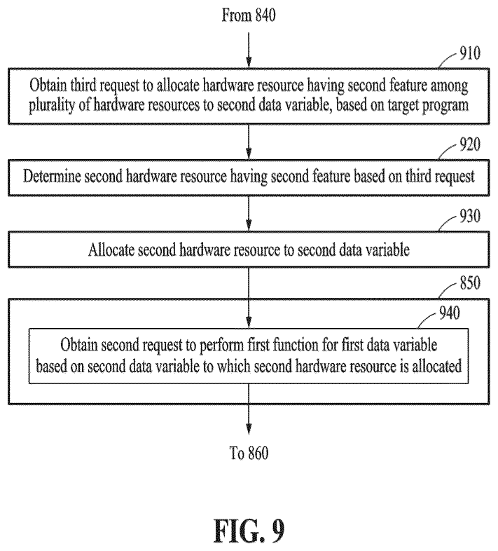

FIG. 9 is a flowchart illustrating a method of obtaining a second request to perform a first function for a first data variable, based on a second data variable to which a second hardware resource is allocated or assigned, according to one or more embodiments.

According to one or more embodiments, operations 910 to 930 of FIG. 9 may be performed after operation 840 described above with reference to FIG. 8 is performed. Operation 850 described above with reference to FIG. 8 may include operation 940 of FIG. 9. Operations 910 to 940 may be performed by a server (e.g., the server 710 of FIG. 7).

In operation 910, the server may obtain a third request to allocate or assign a hardware resource having a second feature among a plurality of hardware resources (e.g., the plurality of hardware resources 711 to 718 of FIG. 7) to a second data variable, based on the target program. The description of operation 510 described above with reference to FIG. 5 may be similarly applied to the description of operation 910.

In operation 920, the server may determine a second hardware resource having the second feature based on the third request. The description of operation 340 described above with reference to FIG. 3 may similarly apply to the description of operation 920.

In operation 930, the server may allocate or assign the second hardware resource to the second data variable. For example, the identifier of the second data variable may be associated with the identifier of the second hardware resource.

In operation 940, the server may obtain the second request to perform the first function for a first data variable based on the second data variable to which the second hardware resource is allocated or assigned.

For example, if a first hardware resource is a container, and the second hardware resource is a sampler, the first function may be a sampling operation of the sampler. For example, if the source code states “hwcall sampler.sampling(source=containerR, target=containerS);”, hwcall represents a command that calls a function of a hardware resource whose second data variable is sampler, and sampling(source=containerR, target=containerS) refers to the first function to sample a material in the first hardware resource whose first data variable is containerR to a hardware resource whose data variable is containerS.

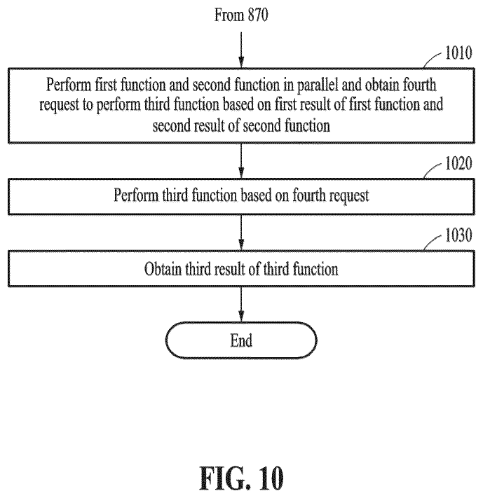

FIG. 10 is a flowchart illustrating a method of obtaining a result of a third function performed based on results of a first function and a second function having performed in parallel, according to one or more embodiments.

According to one or more embodiments, operations 1010 to 1030 of FIG. 10 may be performed after operation 870 described above with reference to FIG. 8 is performed. Operations 1010 to 1030 may be performed by a server (e.g., the server 710 of FIG. 7).

In operation 1010, the server may perform the first function and the second function in parallel and may obtain a fourth request to perform the third function based on a first result of the first function and a second result of the second function. The description of operation 610 described above with reference to FIG. 6 may similarly apply to the description of operation 1010.

In operation 1020, the server may perform the third function based on the fourth request. For example, the server may control equipment specified through the fourth request to perform the third function.

In operation 1030, the server may obtain a third result of the third function. The description of operation 870 described above with reference to FIG. 8 may similarly apply to the description of operation 1030.

The methods according to the above-described embodiments may be recorded in non-transitory computer-readable media including program instructions to implement various operations of the above-described embodiments. The media may also include, alone or in combination with the program instructions, data files, data structures, and the like. The program commands recorded on the above medium may be specially designed and configured for the embodiment or may be known and available to those skilled in the art of computer software. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random-access memory (RAM), flash memory, and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Accordingly, other implementations are within the scope of the following claims.

What is claimed is:

1. A program execution method performed by an electronic device, the program execution method comprising:
obtaining a target program configured to present a workflow for an experiment conducted via an external electronic device configured to control a plurality of hardware resources;
obtaining a first request to assign a hardware resource having a first feature among the plurality of hardware resources to a first data variable, based on the target program;
transmitting the first request to the external electronic device;
receiving, from the external electronic device, information about a first hardware resource having the first feature in response to the first request;
obtaining a second request to perform a first function associated with the first data variable to which the first hardware resource is assigned based on the target program;
transmitting the second request to the external electronic device; and
receiving, from the external electronic device, a first result of the first function in response to the second request.

2. The program execution method of claim 1, wherein the target program comprises source code written based on an imperative programming language.

3. The program execution method of claim 1, wherein the obtaining of the first request comprises:
converting a first script of the target program into one or more tokens;
generating nodes of an abstract syntax tree (AST) for the one or more tokens; and
obtaining the first request based on the nodes of the AST.

4. The program execution method of claim 1, wherein the transmitting of the first request to the external electronic device comprises:
transmitting the first request to a resource management device of the external electronic device configured to manage a state of the plurality of hardware resources.

5. The program execution method of claim 1, wherein the first feature comprises at least one of a type, capacity, or function of the first hardware resource.

6. The program execution method of claim 5, wherein the type of the hardware resource comprises at least one of a material, a container, or equipment.

7. The program execution method of claim 1, wherein the first function comprises at least one of an operation type, operating time, or standby time of the first hardware resource.

8. The program execution method of claim 1, further comprising:
obtaining a third request to assign a hardware resource having a second feature among the plurality of hardware resources to a second data variable, based on the target program;
transmitting the third request to the external electronic device; and
receiving, from the external electronic device, information about a second hardware resource having the second feature in response to the third request,
wherein the obtaining of the second request comprises:
obtaining the second request to perform the first function associated with the first data variable, based on the second data variable to which the second hardware resource is assigned.

9. The program execution method of claim 1, further comprising:
performing the first function and a second function in parallel and obtaining a fourth request to perform a third function based on the first result of the first function and a second result of the second function;
transmitting the fourth request to the external electronic device; and
receiving, from the external electronic device, a third result of the third function in response to the fourth request.

10. The program execution method of claim 1, wherein the electronic device and the external electronic device are included in a server.

11. A non-transitory computer-readable storage medium storing instructions that, when executed by a processor, cause the processor to perform the program execution method of claim 1.

12. An electronic device comprising:
at least one processor comprising processing circuitry; and
a memory comprising one or more storage media configured to store instructions,
wherein the instructions, when executed individually or collectively by the at least one processor, cause the electronic device to
obtain a target program configured to present a workflow for an experiment conducted via an external electronic device configured to control a plurality of hardware resources,
obtain a first request to assign a hardware resource having a first feature among the plurality of hardware resources to a first data variable, based on the target program,
transmit the first request to the external electronic device,
receive, from the external electronic device, information about a first hardware resource having the first feature in response to the first request,
obtain a second request to perform a first function associated with the first data variable to which the first hardware resource is assigned based on the target program,
transmit the second request to the external electronic device, and
receive, from the external electronic device, a first result of the first function in response to the second request.

13. The electronic device of claim 12, wherein
the first feature comprises at least one of a type, capacity, or function of the first hardware resource, and
the type of the hardware resource comprises at least one of a material, a container, or equipment.

14. The electronic device of claim 12, wherein the first function comprises at least one of an operation type, operating time, or standby time of the first hardware resource.

15. The electronic device of claim 12, wherein the electronic device and the external electronic device are included in a server.

16. A program execution method performed by a server, the program execution method comprising:
obtaining a target program configured to present a workflow for an experiment conducted via at least one of a plurality of hardware resources connected to the server;
obtaining a first request to assign a hardware resource having a first feature among the plurality of hardware resources to a first data variable, based on the target program;
determining a first hardware resource having the first feature based on the first request;
assigning the first hardware resource to the first data variable;
obtaining a second request to perform a first function associated with the first data variable;
performing the first function on the first hardware resource based on the second request; and
obtaining a first result of the first function.

17. The program execution method of claim 16, wherein the determining of the first hardware resource comprises:
determining a hardware resource in an idle state, from among one or more candidate hardware resources having the first feature within the plurality of hardware resources, as the first hardware resource.

18. The program execution method of claim 16, wherein the determining of the first hardware resource comprises:
based on all candidate hardware resources having the first feature are in use, determining expected end times for the candidate hardware resources; and
determining the first hardware resource from among the candidate hardware resources based on the expected end times.

19. The program execution method of claim 16, further comprising:
obtaining a third request to assign a hardware resource having a second feature among the plurality of hardware resources to a second data variable, based on the target program;
determining a second hardware resource having the second feature based on the third request; and
assigning the second hardware resource to the second data variable,
wherein the performing of the first function on the first hardware resource based on the second request comprises:
obtaining the second request to perform the first function associated the first data variable, based on the second data variable to which the second hardware resource is assigned.

20. The program execution method of claim 16, further comprising:
performing the first function and a second function in parallel and obtaining a fourth request to perform a third function based on the first result of the first function and a second result of the second function;
performing the third function based on the fourth request; and
obtaining a third result of the third function.
